(19) United States
(12) Patent Application Publication
(10) Pub. No.: US 2021/0137089 A1
(43) Pub. Date: May 13, 2021

(54) FISHING ACCESSORY LINE MANAGEMENT DEVICE

(71) Applicant: Otsego Precision Machine Inc, Otsego, MN (US)

(72) Inventor: Jene D. Williams, Otsego, MN (US)

(73) Assignee: Otsego Precision Machine Inc, Otsego, MN (US)

(21) Appl. No.: 16/678,283

(22) Filed: Nov. 8, 2019

(51) Int. Cl. A01K 91/08

(52) U.S. Cl. CPC A01K 91/08

(57) ABSTRACT

Disclosed herein is a fishing accessory line management device for use in storing and coupling to a paravane-type fishing accessory such as a planing device. In embodiments, the planing device includes a vertical fin and a horizontal plane. The fishing accessory line management device can include a cantilevered portion and a base coupled to the cantilevered portion. The fishing accessory line management device can also include a fin channel defined by fin channel walls within the cantilevered portion. The fin channel can be sized and shaped to receive the fin. The fishing accessory line management device can further include a plane channel defined by plane channel walls within the cantilevered portion. The plane channel can be sized and shaped to receive the plane. In embodiments, the base and cantilevered portion are configured such that a portion of fishing line can be wrapped around the base and the cantilevered portion.

### TECHNICAL FIELD

This disclosure relates to fishing accessories, and in particular, organizational devices for paravane-type fishing rigs.

### BACKGROUND

Trolling is a popular form of fishing, especially for sport fishing in large bodies of water, such as oceans and large lakes. Trolling includes pulling a baited fishing line behind a slowly moving boat. In order to keep the bait at a desired depth while moving, a downrigger or paravane can be used. Downrigging conventionally uses heavy weights to keep bait at a desired depth while paravanes use the down force created by an angled plane moving through water to keep the bait at a desired depth. While effective, conventional downrigging and paravane-type trolling devices can be expensive and cumbersome.

Cost-effective paravane-type fishing accessories have emerged as a popular solution to expensive and cumbersome conventional downrigging and paravane-type trolling. A popular example of cost-effective paravane-type fishing accessory is a planing device. Dipsy Divers™ are small planing devices coupled to the fishing line between the bait and the boat via fishing pole or other line-reeling device. Planing devices, such as Dipsy Divers™, operate similarly to conventional paravane-type rigs, but are simpler in form and function. Often, the Planing device and bait rig are arranged at an end of the fishing line such that a desired depth of plane can be achieved when the rigging is pulled behind a boat.

Planing devices are often included as the first coupling point to a baited rig such that planing device-baited rigs are quickly coupleable to a main fishing line. A planing device-baited rig is often coupled to a first end of a length of fishing line, and a bait portion is arranged at a second end of the fishing line. The length of fishing line used within the rig can range from ½ meters to 10 meters. Planing device-baited rigs are often assembled prior to use and stored on the boat such that they can be used on short notice.

On fishing boats, especially commercial or high output fishing boats, a large number of pre-assembled planing device-baited rigs are made available on the boat. Planing device-baited rigs present an organizational and safety issue on the boat deck, however, due to the lengths of fishing line. The lengths of fishing line can easily stray and become snagged or tangled. Various planing device holders have been developed to contain the planing device to a fishing rod or to a wall or other portion of a boat. Conventional planing device holders, however, do not provide adequate storage for multiple planing device-baited rigs that are easily accessible and position the planing device-baited rigs such that they can be put into use quickly.

### SUMMARY

Disclosed herein are embodiments of a fishing accessory line management device configured to secure and organize a planing device rig, such as a rig incorporating a Dipsy Diver™. The fishing accessory line management device includes a base portion and a cantilevered portion. The cantilevered portion includes a plurality of channels configured to align and engage with various structures of the planing device. The housing is configured to provide a wrapping surface such that the length of fishing line and bait portion can be wrapped around the housing when the planing device is coupled to the fishing accessory line management device. When the planing device is coupled to the fishing accessory line management device, the tension and friction created by wrapping the length of fishing line and bait portion around the housing secures the planing device to the fishing accessory line management device. When a fisherman is ready to use the planing device rig, the fisherman can pull the planing device out of the housing while the length of fishing line is unraveled.

In particular, one embodiment of a fishing accessory line management device for use in storing and coupling to a planing device includes a vertical fin and a horizontal plane. The fishing accessory line management device can include a cantilevered portion and a base coupled to the cantilevered portion. The fishing accessory line management device can also include a fin channel defined by fin channel walls within the cantilevered portion. The fin channel can be sized and shaped to receive the fin. The fishing accessory line management device can further include a plane channel defined by plane channel walls within the cantilevered portion. The plane channel can be sized and shaped to receive the plane. In embodiments, the base and cantilevered portion are configured such that a portion of fishing line can be wrapped around the base and the cantilevered portion.

In an alternative embodiment, a fishing accessory line management system can include a board and one or more fishing accessory line management devices. The board can further include one or more fishing accessory line management device couplings. Each of the one or more fishing accessory line management devices can include one or more coupling apertures. The one or more coupling apertures can be coupleable to one of the one or more fishing accessory line management device couplings of the board.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a parametric view of a fishing accessory line management device and a paravane-type fishing accessory, according to embodiments described herein.

FIG. 2A is an isometric view of a fishing accessory line management device, according to embodiments described herein.

FIG. 2B is a front view of a fishing accessory line management device, according to embodiments described herein.

FIG. 2C is a side view of a fishing accessory line management device, according to embodiments described herein.

FIG. 2D is an isometric cross-section view of a fishing accessory line management device, according to embodiments described herein.

FIG. 2E is a top view of a fishing accessory line management device, according to embodiments described herein.

FIG. 3A is a front view of a fishing accessory line management device and a paravane-type fishing accessory, according to embodiments described herein.

FIG. 3B is an isometric view of a plurality of fishing accessory line management devices coupled to a storage rack, according to embodiments described herein.

FIG. 4 is a series of snapshots depicting a method of use of a fishing accessory line management device and a paravane-type fishing accessory, according to embodiments described herein.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Disclosed herein are a fishing accessory line management device and associated systems and methods. Embodiments of the fishing accessory line management device include a housing configured to selectively couple to a planing device rig. In embodiments, the planing device rig includes a planing device, a length of fishing line, and a bait portion. The housing of the fishing accessory line management device includes a base portion and a cantilevered portion. The cantilevered portion includes a plurality of channels configured to align and engage with various structures of the planing device. The housing is configured to provide a wrapping surface such that the length of fishing line and bait portion can be wrapped around the housing when the planing device is coupled to the fishing accessory line management device. When the planing device is coupled to the fishing accessory line management device, the tension and friction created by wrapping the length of fishing line and bait portion around the housing secures the planing device to the fishing accessory line management device. When a fisherman is ready to use the planing device rig, the fisherman can pull the planing device out of the housing while the length of fishing line is unraveled. It is understood that a particular product (i.e., a planing device commercially known as the Dipsy Diver™) is used throughout this disclosure embodiments of the fishing accessory line management device are equally suitable for use with other similarly shaped paravane-type fishing accessories.

In embodiments as depicted in FIG. 1, a cost-effective paravane-type fishing accessory known in the art, such as a planing device 84 commercially known as a Dipsy Diver™, generally includes a plane 86 and a fin 88. Plane 86 and fin 88 are sized and shaped to provide down force to a baited rig while trolling to maintain a preferred bait depth. Planing device 84 also includes a line coupling 90, and a rig coupling 92. Planing device 84 is coupleable to a rig line 94 and a bait coupling 96. Line coupling 90 is configured to couple to a fishing line originating on the boat via fishing pole or other line reeling device. Rig coupling 92 is configured to couple to rig line 94 at a first end of rig line 94. Rig line 94 can vary in length between ½ meters and 10 meters depending on a fisherman's preference. Bait coupling 96 is coupled to a second end of rig line 94. Bait coupling 96 is configured to couple various bait such as fishing lures, live bait, or other suitable types of bait. Planing device 84, rig line 94, bait coupling 96, and bait are considered components of a planing device rig 98. Planing device 84 can come in a variety of sizes and materials suited for various targeted fish or merely fisherman's preference.

Also depicted in FIG. 1 is a fishing accessory line management device 100 for use in securing and organizing planing device rig 98. FIG. 1 depicts fishing accessory line management device 100 coupled to planing device rig 98 in a storage position.

Referring now to FIG. 2A-2E, fishing accessory line management device 100 includes a housing 110. Housing 110 further includes a base 112 and a cantilevered portion 114. Cantilevered portion 114 can include a fin channel 118 and plane channel 120. Base 112 and cantilevered portion 114 are unitarily coupled via base transition 122. Base transition 122 can comprise a flared portion of housing 110 configured to provide a gradual wall transition from cantilevered portion 114 and base 112. Base transition 112 can include a flared wall having a concave radius, or in other embodiments, base transition 112 can include a flared wall that is substantially straight. Housing 110 further includes a plurality of ribs 124 arranged throughout the inner cavity of housing 110.

Fin channel 118, as depicted in FIG. 2B, further includes a receiving portion 128 and an end portion 130. Receiving portion 128 and end portion 130 of fin channel 118 are sized and shaped to receive and secure fin 88 of planing device 84. In some embodiments, receiving portion 128 can include flared walls so as to align and guide fin 88 of planing device 84. In an embodiment as depicted in FIG. 2B, receiving portion 128 includes wall that are substantially straight. End portion 130 is configured to provide a mechanical stop for fin 88 to rest when planing device rig 98 is in a storage position. In some embodiments, fin channel 118 can include protrusions extending inwardly towards fin 88 such that the protrusions provide additional friction force for use in securing planing device rig 98 to fishing accessory line management device 100.

Plane channel 120, as depicted in FIG. 2C, further includes a receiving portion 136 and an end portion 138. Receiving portion 136 and end portion 138 of plane channel 120 are sized and shaped to receive and secure plane 86 of planing device 84 on either side of fin 88. In the embodiment as depicted in FIG. 2C, receiving portion 136 can include flared walls so as to align and guide plane 86 of planing device 84. In other embodiments, receiving portion 136 includes wall that are substantially straight. End portion 138 is configured to provide a mechanical stop for plane 86 to rest when planing device rig 98 is in a storage position. In some embodiments, plane channel 120 can include protrusions extending inwardly towards plane 86 such that the protrusions provide additional friction force for use in securing planing device rig 98 to fishing accessory line management device 100.

Ribs 124, as depicted in FIGS. 2D and 2E, include a base portion 144 and a cantilevered portion 146. Ribs 124 are configured to span the internal cavity of housing 110 in order to provide structural support for housing 110. In this embodiment, there are 5 ribs supporting housing 110. Other embodiments of housing 110 can include less than 5 ribs or between 6-20 ribs. Each rib 124 can comprise a thickness suitable for an injection molding process with respect to a wall thickness of housing 110. In other embodiments, ribs 124 can have a substantially thinner or thicker wall thickness compared to the wall thickness of housing 110. In this embodiment, base portion 144 spans the cross-section of housing 110 in order to provide structural integrity to housing 110. Cantilevered portion 146 extends from the inner wall of housing 110 to plane channel 120. Cantilevered portion 146 is configured to provide structural integrity to cantilevered portion 114 of housing 110.

In an alternative embodiment depicted in FIG. 3A, fishing accessory line management device 200 includes housing 210, base 212, and cantilevered portion 214. Fishing accessory line management device 200 also includes one or more coupling apertures 216. In one embodiment, coupling apertures 216 can be arranged at base 212 such that when planing device rig 98 and fishing accessory line management device 200 are in a storage position, planing device rig 98 and fishing accessory line management device 200 can be hung on a hook or other protrusion for storage purposes. In fishing accessory line management storage system, coupling apertures 216 or base 212 can be configured to selectively couple to a storage rack for one or more fishing accessory line management devices 200.

In one embodiment and referring now to FIG. 3B, fishing accessory line management device 200 can be configured to couple to a storage rack 250. Storage rack 250 can further include one or more mounting apertures 254 and one or more channels 256. Mounting apertures 254 are arranged on storage rack 250 such that storage rack 250 can be mounted to a wall or other vertical support structure. Storage rack 250 can be mounted a horizontal position, vertical position, overhead position, or a variety of other positions. One or more channels 256 are sized and shaped to receive base 112 or 212 of fishing accessory line management device 100 or 200, respectively. One or more channels 256 include an open receiving end 258 and a terminating end 260. In use, base 112 or 212 of fishing accessory line management device 100 or 200, respectively is inserted into one of the one or more channels 256 at the open receiving end 258. Base 112 or 212 of fishing accessory line management device 100 or 200 traverses one of the one or more channels 256 until base 112 or 212 reaches terminating end 260 of the one of the one or more channels 256 such that fishing accessory line management device 100 or 200 is in a storage position. Fishing accessory line management device 100 or 200 can then be removed from storage rack 250 by sliding fishing accessory line management device 100 or 200 away from terminating end 260 until base 112 or 212 is free of one of the one or more channels 256. In embodiments, storage rack 250 can be made of polypropylene, aluminum, or other suitable material.

In alternative embodiments, storage rack 250 can include coupling components corresponding to coupling apertures 216 of one or more fishing accessory line management device 200 in lieu of one or more channels 256.

Fishing accessory line management device 100 and 200 can comprise unitary construction via injection molding, machining, forging or other suitable construction methods. In alternative embodiments, fishing accessory line management device 100 can be constructed of a plurality of components assemble via known fixation method such as screws, snap-fit couplings, press fit couplings or other weldment. Fishing accessory line management device 100 can be made of plastic material such as polypropylene or other suitable plastic material. In alternative embodiments, fishing accessory line management device 100 can also be made of other non-corroding materials such as aluminum or other suitable material.

In use and as depicted in FIGS. 4A-4B, a planing device rig 98 can be selectively coupled to fishing accessory line management device 100 by first positioning planing device 84 such that fin 88 and plane 86 can be received by fin channel 118 and plane channel 120, respectively at 400. At 402, fishing line accessory management device 100 and planing device 84 can be slid together such that fin 88 and plane 86 travel through receiving portion 128 of fin channel 118 and receiving portion 136 of plane channel 120, respectively. At 404, fin 88 and plane 86 are mechanically stopped at end portion 130 of fin channel 118 and end portion 138 of plane channel 120.

At 406, the fisherman can begin winding rig line 94 around housing 100 at base transition 122. The friction force of rig line 94 being wound around housing 100 can provide a portion of the force needed to selectively retain planing device 84 to fishing accessory line management device 100. At 408, planing device rig 98 and fishing accessory line management device 100 are in a storage position, planing device rig 98 being selectively coupled to fishing accessory line management device 100 via friction force created by the rig line 94 winding and engagement surfaces of cantilevered portion 114 engaging with plane 86 and fin 88. At 404, a fisherman can remove planing device rig 98 from fishing accessory line management device 100 by holding fishing accessory line management device 100 at base 112 and base transition 122 and pulling planing device 84 away from fishing accessory line management device 100. While planing device 84 is moving away from fishing accessory line management device 100, rig line 94 unwinds until there are no more rig line 94 windings around housing 110 and planing device rig 98 is free of fishing accessory line management device 100.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

1. A fishing accessory line management device for use in storing and coupling to a planing device, the planing device including a vertical fin and a horizontal plane, the device comprising:
a cantilevered portion;
a base coupled to the cantilevered portion at a first end of the cantilevered portion;
a fin channel defined by fin channel walls within the cantilevered portion, the fin channel sized and shaped to receive the fin;
a plane channel defined by plane channel walls within the cantilevered portion, the plane channel sized and shaped to receive the plane; and
wherein the base and cantilevered portion are configured such that a portion of fishing line can be wrapped around the base and the cantilevered portion.

2. The fishing accessory line management device of claim 1 further comprising a base transition coupling the base to the cantilevered portion.

3. The fishing accessory line management device of claim 2, wherein the base transition includes a wall having a concave curvature.

4. The fishing accessory line management device of claim 1, the plane channel further comprising a receiving portion having flared walls, the flared walls configured to guide the plane of the planing device.

5. The fishing accessory line management device of claim 1 further including one or more coupling apertures arranged proximal to the base.

6. The fishing accessory line management device of claim 1, wherein the plane channel walls include one or more extrusions, the one or more extrusions configured to engage the plane.

7. The fishing accessory line management device of claim 1 further including one or more ribs spanning an interior cavity of the fishing accessory line management device.

8. The fishing accessory line management device of claim 1 further including one or more coupling apertures configured for mounting to a board, the board including one or more corresponding fishing accessory line management device couplings.

9. A fishing accessory line management system for use in storing and coupling to a planing device, the planing device including a vertical fin and a horizontal plane, the system comprising:
a board, the board including one or more fishing accessory line management device couplings; and
a fishing accessory line management device, the fishing accessory line management device including:
a cantilevered portion,
a base coupled to the cantilevered portion at a first end of the cantilevered portion,
one or more coupling apertures, the one or more coupling apertures being coupleable to one of the one or more fishing accessory line management device couplings of the board,
a fin channel defined by fin channel walls within the cantilevered portion, the fin channel sized and shaped to receive the fin,
a plane channel defined by plane channel walls within the cantilevered portion, the plane channel sized and shaped to receive the plane, and
wherein the base and cantilevered portion are configured such that a portion of fishing line can be wrapped around the base and the cantilevered portion.

10. The fishing accessory line management system of claim 9 further comprising a base transition coupling the base to the cantilevered portion.

11. The fishing accessory line management system of claim 10, wherein the base transition includes a wall having a concave curvature.

12. The fishing accessory line management device of claim 9, the plane channel further comprising a receiving portion having flared walls, the flared walls configured to guide the plane of the planing device.

13. The fishing accessory line management device of claim 9 further including one or more coupling apertures arranged proximal to the base.

14. The fishing accessory line management device of claim 9, wherein the plane channel walls include one or more extrusions, the one or more extrusions configured to engage the plane.

15. The fishing accessory line management device of claim 9 further including one or more ribs spanning an interior cavity of the fishing accessory line management device.

16. A fishing accessory line management device for use in storing and coupling to a planing device, the planing device including a vertical fin and a horizontal plane, the device comprising:
a unitary housing, the unitary housing further including:
a cantilevered portion,
a base coupled to the cantilevered portion at a first end of the cantilevered portion,
a fin channel defined by fin channel walls within the cantilevered portion, the fin channel sized and shaped to receive the fin,
a plane channel defined by plane channel walls within the cantilevered portion, the plane channel sized and shaped to receive the plane, and
wherein the base and cantilevered portion are configured such that a portion of fishing line can be wrapped around the base and the cantilevered portion.
